(19) United States
(12) Patent Application Publication
(10) Pub. No.: US 2001/0029495 A1
(43) Pub. Date: Oct. 11, 2001

(54) Mail-order system using network and mail-ordering method thereof

(76) Inventors: Toshio Yagihashi, Tokyo (JP); Shouji Narisawa, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/825,333

(22) Filed: Apr. 4, 2001

(30) Foreign Application Priority Data
Apr. 5, 2000 (JP) 102951/2000

(51) Int. Cl. G06F 17/60

(52) U.S. Cl. 705/67

(57) ABSTRACT

In a case of accessing a site side server through an Internet network to purchase a commodity, enciphering and registering personal authentication information and physical characteristic information so as to be correlated with other on the side of a server for members enable personal authentication by the application of physical characteristics even when personal authentication information is forgotten, so that connection to a mail-order system using the Internet network is enabled to release members from conducting management of various personal authentication information and security can be ensured as well.

### BACKGROUND OF THE INVENTION

1. Field of the Invention

The present invention relates to a mail-order system for making a purchase and a settlement of commodities using a computer through a public line such as the Internet and a method thereof, an Internet connection system and a method thereof and, more particularly, to a system and a method suitable for the management of member identification information, a password and the like.

2. Description of the Related Art

One of conventional systems for electronic transactions of commodities by which purchase and settlement of commodities are made using a computer through a public line such as the Internet is a system disclosed in Japanese Patent Laying-Open No. 10-21305. The system will be described with reference to FIG. 9.

In FIG. 9, with the system disclosed in Japanese Patent Laying-Open No. 10-21305, at the time of purchase, a purchaser of a commodity adds his or her own physical characteristic information and a search code for searching the information to purchase information at a second information processing device 92 to transmit the obtained information to a third information processing device 93 through an Internet 94. Then, the third information processing device 93 determines whether numbers of physical characteristic information stored to have a state searchable by a search code in a storage medium as information to be collated and the physical characteristic information transmitted from the purchaser coincide with each other or not and when they coincide with each other, sends purchase information to a first information processing device 91 on the commodity dealing side. These procedures realize electronic transactions of commodities.

In the above-described electronic commodity transaction system, however, information on a purchaser as a subject of transaction, that is, a member, needs to be stored to have a state searchable by a search code in a storage medium in the third information processing device 93 as information to be collated.

Accordingly, when a new purchaser who wants to start transactions appears or when stored physical characteristic information disappears or becomes unsearchable for some reason or other, electronic commodity transactions might be impossible because there exists no input means for such information other than physical characteristic information inherent to a purchaser as personal authentication information for authenticating a member including member identification information and a password.

### SUMMARY OF THE INVENTION

An object of the present invention is, in order to solve the above-described problems, to provide a mail-order system enabling access to a server on the side of a mail-order site through a network by using personal authentication information for authenticating a new purchaser as a member or, after the registration of authentication information, authenticating the purchaser as a member in response to application of physical characteristics of the purchaser himself or herself, and a mail-ordering method thereof.

According to the first aspect of the invention, a mail-order system for members by which a member purchases commodities by accessing a mail-order site side server through a network using such personal authentication information for authenticating a member as member identification information and a password, comprises

registration unit for registering physical characteristics of each the member in advance, and

processing unit responsive to application of physical characteristics by a purchaser for comparing the applied physical characteristic information and the physical characteristic information registered at the registration unit to conduct authentication and determining whether connection to the mail-order site side server through the network is allowed or not according to authentication results.

In the preferred construction, the mail-order system further comprises a server for members for authenticating the member, wherein

the registration unit and the processing unit are provided at the server for members.

In another preferred construction, the mail-order system further comprises unit for enciphering the personal authentication information and the physical characteristic information so as to be in correlation with each other and registering the enciphered information at the registration unit, and reading and decoding the information enciphered.

In another preferred construction, the mail-order system further comprises unit for enciphering the personal authentication information and the physical characteristic information so as to be in correlation with each other and registering the enciphered information at the registration unit, and reading and decoding the information enciphered, wherein

the decoding unit decodes the personal authentication information when results of authentication of a purchaser's physical characteristics applied at the purchase of a commodity and the registered physical characteristics coincide with each other.

In another preferred construction, the mail-order system further comprises unit for enciphering the personal authentication information and the physical characteristic information so as to be in correlation with each other and registering the enciphered information at the registration unit, and reading and decoding the information enciphered, wherein

the decoding unit decodes the personal authentication information when results of authentication of a purchaser's physical characteristics applied at the purchase of a commodity and the registered physical characteristics coincide with each other, and

the processing unit transmits the personal authentication information decoded to the mail-order site side server.

According to the second aspect of the invention, a mail-order system for members by which a member makes a settlement for mail-ordering by accessing a mail-order settlement server through a network using such authentication information for authenticating a card of a member who makes a settlement for mail-ordering as identification information and a password, comprises

registration unit for registering physical characteristics of each the member in advance, and

processing unit responsive to application of physical characteristics of one who makes a settlement and to application of physical characteristics by a purchaser for comparing the applied physical characteristic information and the physical characteristic information registered at the registration unit to conduct authentication and determining whether connection to the mail-order settlement server through the network is allowed or not according to authentication results.

In the preferred construction, the mail-order system further comprises a server for members for authenticating the member, wherein

the registration unit and the processing unit are provided at the server for members.

In another preferred construction, the mail-order system further comprises unit for enciphering the personal authentication information and the physical characteristic information so as to be in correlation with each other and registering the enciphered information at the registration unit, and reading and decoding the information enciphered.

In another preferred construction, the mail-order system further comprises unit for enciphering the personal authentication information and the physical characteristic information so as to be in correlation with each other and registering the enciphered information at the registration unit, and reading and decoding the information enciphered, wherein

the decoding unit decodes the personal authentication information when results of authentication of physical characteristics of one who makes a settlement applied at the settlement of mail-ordering and the registered physical characteristics coincide with each other.

In another preferred construction, the mail-order system further comprises unit for enciphering the personal authentication information and the physical characteristic information so as to be in correlation with each other and registering the enciphered information at the registration unit, and reading and decoding the information enciphered, wherein

the decoding unit decodes the personal authentication information when results of authentication of physical characteristics of one who makes a settlement applied at the settlement of mail-ordering and the registered physical characteristics coincide with each other, and

the processing unit transmits the personal authentication information decoded to the mail-order settlement server.

According to the third aspect of the invention, an Internet connection system enabling connection to at least one of contracted providers by member's access to the Internet through a network using such personal authentication information for authenticating a member as member identification information and a password, comprises

registration unit for registering physical characteristics of each the member in advance, and

processing unit responsive to application of physical characteristics by one who makes a connection for comparing the applied physical characteristic information and the physical characteristic information registered at the registration unit to conduct authentication and determining whether connection to the provider through the network is allowed or not according to authentication results.

In the preferred construction, the Internet connection system further comprises a server for members for authenticating the member, wherein

the registration unit and the processing unit are provided at the server for members.

In another preferred construction, the Internet connection system further comprises unit for enciphering the personal authentication information and the physical characteristic information so as to be in correlation with each other and registering the enciphered information at the registration unit, and reading and decoding the information enciphered.

In another preferred construction, the Internet connection system further comprises unit for enciphering the personal authentication information and the physical characteristic information so as to be in correlation with each other and registering the enciphered information at the registration unit, and reading and decoding the information enciphered, wherein

the decoding unit decodes the personal authentication information when results of authentication of physical characteristics of one who makes a connection applied at the connection and the registered physical characteristics coincide with each other.

In another preferred construction, the Internet connection system further comprises unit for enciphering the personal authentication information and the physical characteristic information so as to be in correlation with each other and registering the enciphered information at the registration unit, and reading and decoding the information enciphered, wherein

the decoding unit decodes the personal authentication information when results of authentication of physical characteristics of one who makes a connection applied at the connection and the registered physical characteristics coincide with each other, and

the processing unit transmits the personal authentication information decoded to the provider.

According to another aspect of the invention, a mail-ordering method for members by which a member purchases commodities by accessing a mail-order site side server through a network using such personal authentication information for authenticating a member as member identification information and a password, comprising the steps of

registering physical characteristics of each the member in advance, and

in response to application of physical characteristics by a purchaser, comparing the applied physical characteristic information and the physical characteristic information registered at the registration unit to conduct authentication and determining whether connection to the mail-order site side server through the network is allowed or not according to authentication results.

In the preferred construction, the mail-ordering method further comprising the step of

enciphering the personal authentication information and the physical characteristic information so as to be in correlation with each other and registering the enciphered information at the registration unit, and reading and decoding the information enciphered.

In another preferred construction, the mail-ordering method further comprising the step of

enciphering the personal authentication information and the physical characteristic information so as to be in correlation with each other and registering the enciphered information at the registration unit, and reading and decoding the information enciphered, wherein

the personal authentication information is decoded when results of authentication of a purchaser's physical characteristics applied at the purchase of a commodity and the registered physical characteristics coincide with each other.

In another preferred construction, the mail-ordering method further comprising the step of

enciphering the personal authentication information and the physical characteristic information so as to be in correlation with each other and registering the enciphered information at the registration unit, and reading and decoding the information enciphered, wherein

the personal authentication information is decoded when results of authentication of a purchaser's physical characteristics applied at the purchase of a commodity and the registered physical characteristics coincide with each other, and

the personal authentication information decoded is transmitted to the mail-order site side server.

According to another aspect of the invention, a mail-ordering method for members by which a member makes a settlement for mail-ordering by accessing a mail-order settlement server through a network using such authentication information for authenticating a card of a member who makes a settlement for mail-ordering as identification information and a password, comprising the steps of

registering physical characteristics of each the member in advance, and

in response to application of physical characteristics of one who makes a settlement and to application of physical characteristics by a purchaser for comparing the applied physical characteristic information and the physical characteristic information registered at the registration unit to conduct authentication and determining whether connection to the mail-order settlement server through the network is allowed or not according to authentication results.

In the preferred construction, the mail-ordering method further comprising the step of

enciphering the personal authentication information and the physical characteristic information so as to be in correlation with each other and registering the enciphered information at the registration unit, and reading and decoding the information enciphered.

In another preferred construction, the mail-ordering method further comprising the step of

enciphering the personal authentication information and the physical characteristic information so as to be in correlation with each other and registering the enciphered information at the registration unit, and reading and decoding the information enciphered, wherein

the personal authentication information is decoded when results of authentication of physical characteristics of one who makes a settlement applied at the settlement of mail-ordering and the registered physical characteristics coincide with each other.

In another preferred construction, the mail-ordering method further comprising the step of

enciphering the personal authentication information and the physical characteristic information so as to be in correlation with each other and registering the enciphered information at the registration unit, and reading and decoding the information enciphered, wherein

the personal authentication information is decoded when results of authentication of physical characteristics of one who makes a settlement applied at the settlement of mail-ordering and the registered physical characteristics coincide with each other, and

the personal authentication information decoded is transmitted to the mail-order settlement server.

According to a further aspect of the invention, an Internet connection method enabling connection to at least one of contracted providers by member's access to the Internet through a network using such personal authentication information for authenticating a member as member identification information and a password, comprising the steps of

registering physical characteristics of each the member in advance, and

in response to application of physical characteristics by one who makes a connection, comparing the applied physical characteristic information and the physical characteristic information registered at the registration unit to conduct authentication and determining whether connection to the provider through the network is allowed or not according to authentication results.

In the preferred construction, the Internet connection method further comprising the step of

enciphering the personal authentication information and the physical characteristic information so as to be in correlation with each other and registering the enciphered information at the registration unit, and reading and decoding the information enciphered.

In another preferred construction, the Internet connection method further comprising the step of

enciphering the personal authentication information and the physical characteristic information so as to be in correlation with each other and registering the enciphered information at the registration unit, and reading and decoding the information enciphered, wherein

the personal authentication information is decoded when results of authentication of physical characteristics of one who makes a connection applied at the connection and the registered physical characteristics coincide with each other.

In another preferred construction, the Internet connection method further comprising the step of

enciphering the personal authentication information and the physical characteristic information so as to be in correlation with each other and registering the enciphered information at the registration unit, and reading and decoding the information enciphered, wherein

the personal authentication information is decoded when results of authentication of physical characteristics of one who makes a connection applied at the connection and the registered physical characteristics coincide with each other, and

the personal authentication information decoded is transmitted to the provider.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a diagram showing an example of setup of a mail-order system according to a first embodiment of the present invention;

FIG. 2 is a diagram showing an example of setup of a mail-order system according to a second embodiment of the present invention;

FIG. 3 is a diagram showing an example of setup of an Internet connection system according to a third embodiment of the present invention;

FIG. 4 is a flow chart for use in explaining processing to be conducted when personal authentication information and physical characteristic information are applied;

FIG. 5 is a flow chart for use in explaining processing to be conducted at the purchase of a commodity;

FIG. 6 is a diagram showing an example of arrangement of a personal authentication information table and an encipherment table;

FIG. 7 is a diagram showing an example of display of a display unit of the present invention;

FIG. 8 is a diagram showing an another example of display of a display unit of the present invention;

FIG. 9 is a diagram showing an example of setup of a conventional electronic commodity transaction system.

### DESCRIPTION OF THE PREFERRED EMBODIMENTS

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

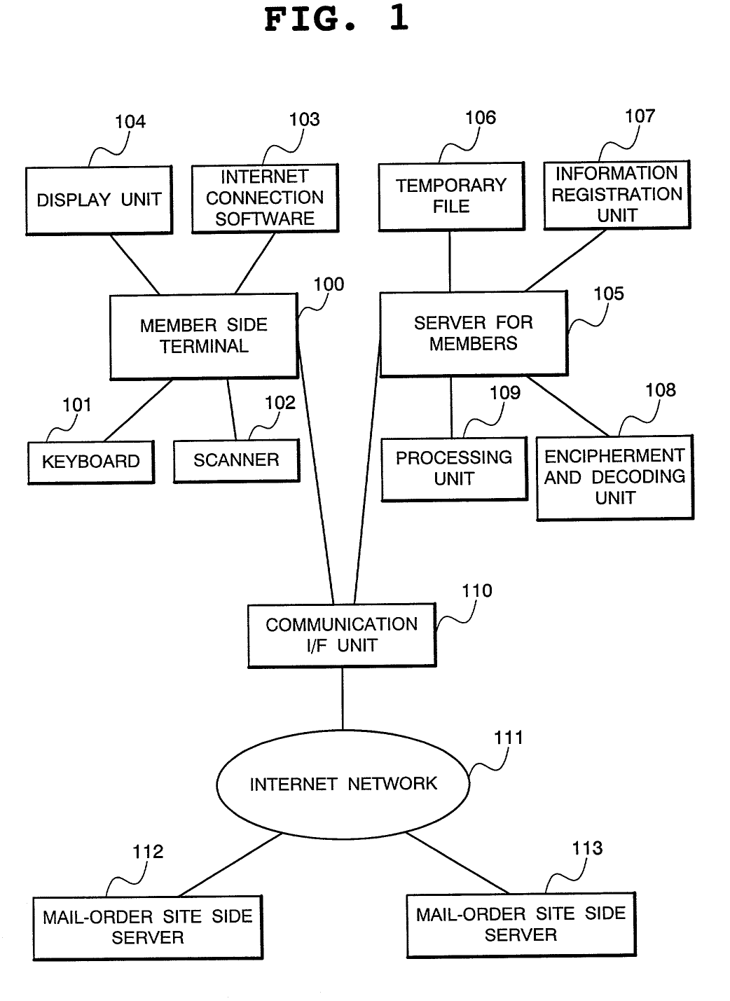

With reference to FIG. 1, shown is an example of setup of a mail-order system as a first embodiment of the present invention. In FIG. 1, 100 denotes a user (member) side terminal and 105 denotes a server for members for conducting management and authentication of member information, both of which are connected to an Internet network 111 through a communication interface unit 110. A mail-order site side sever 112 or 113 is also connected to the Internet network 111. Moreover, the communication interface unit 110 and the Internet network 111 constitute a public line network.

Connected to the user side terminal 100 are a keyboard 101 for inputting personal authentication information of a member, a scanner 102 for inputting physical characteristics and the like of a member, an Internet connection software 103 and a display unit 104.

Connected to the server for members 105 are a temporary file 106 for storing member's personal authentication information, an information registration unit 107 for registering member's physical characteristics, an encipherment and decoding unit 108 for enciphering physical characteristic information and personal authentication information so as to be correlated with each other or decoding personal authentication information from applied physical characteristics and a processing unit 109 responsive to application of physical characteristics for comparing the applied characteristics and registered information of the information registration unit 107 to conduct authentication and responsive to authentication results for allowing or not allowing connection to the mail-order site side server 112 or 113 through the communication interface unit 110.

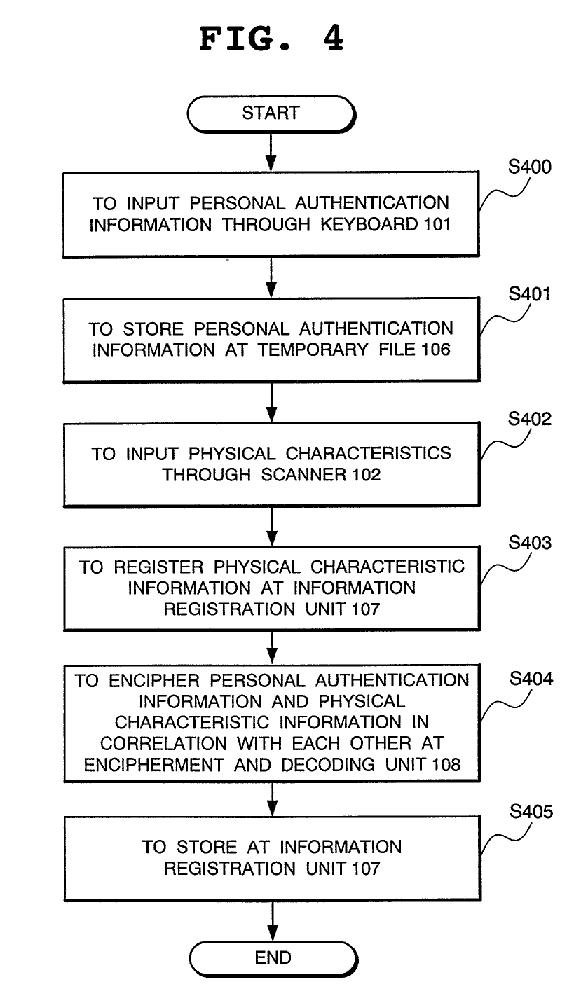

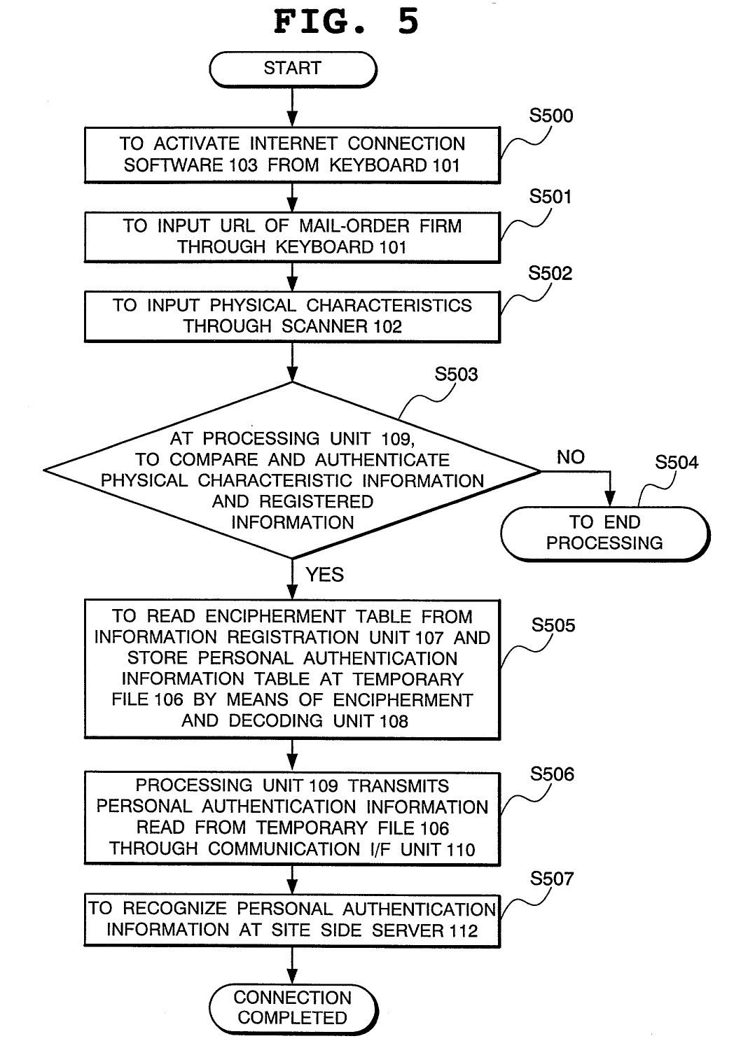

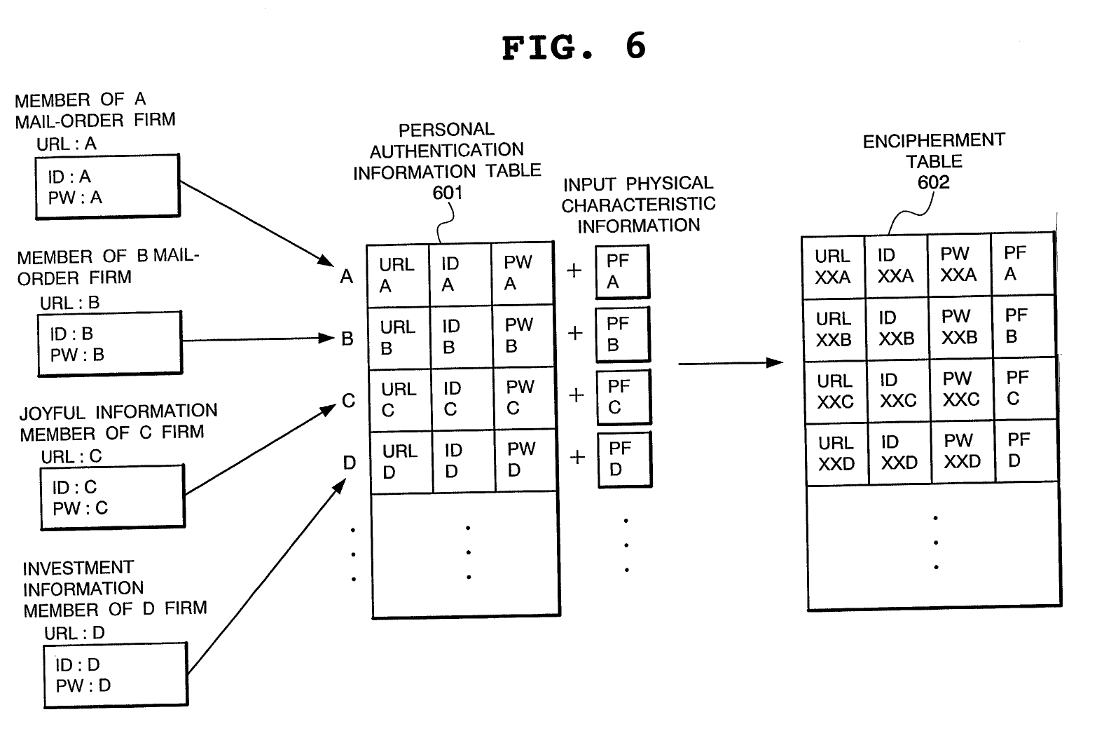

Next, operation of the example of the system setup shown in FIG. 1 will be described with reference to processing flows of FIGS. 4 and 5. FIG. 4 shows a flow of processing to be conducted when personal authentication information and physical characteristic information are input. In FIG. 4, a user (member) inputs such personal authentication information for authenticating a member as member identification information (ID) and a password (PW) through the keyboard 101 (Step S400). The input personal authentication information is stored as such a personal authentication information table 601 as shown in FIG. 6 in the temporary file 106 for storing member's personal authentication information of the server for members 105 through the communication interface unit 110 (Step S401).

Next, the member inputs his or her own physical characteristics (e.g. finger print and palm print) through the scanner 102 (Step S402). Then, the input physical characteristic information PF is registered at the information registration unit 107 of the server for members 105 (Step S403). Thereafter, the physical characteristic information PF and member's personal authentication information are enciphered in correlation with each other by the encipherment and decoding unit 108 (Step S404). Lastly, the enciphered data is stored at the information registration unit 107 as such an encipherment table 602 as illustrated in FIG. 6 (Step S405).

Next, description will be made of FIG. 5 which shows a flow of processing to be conducted when a member purchases commodities. In FIG. 5, the member activates the Internet connection software 103 through the keyboard 101 (Step S500). Moreover, the member inputs an URL (Uniform Resource Location) of a mail-order firm from which purchase is made (Step S501).

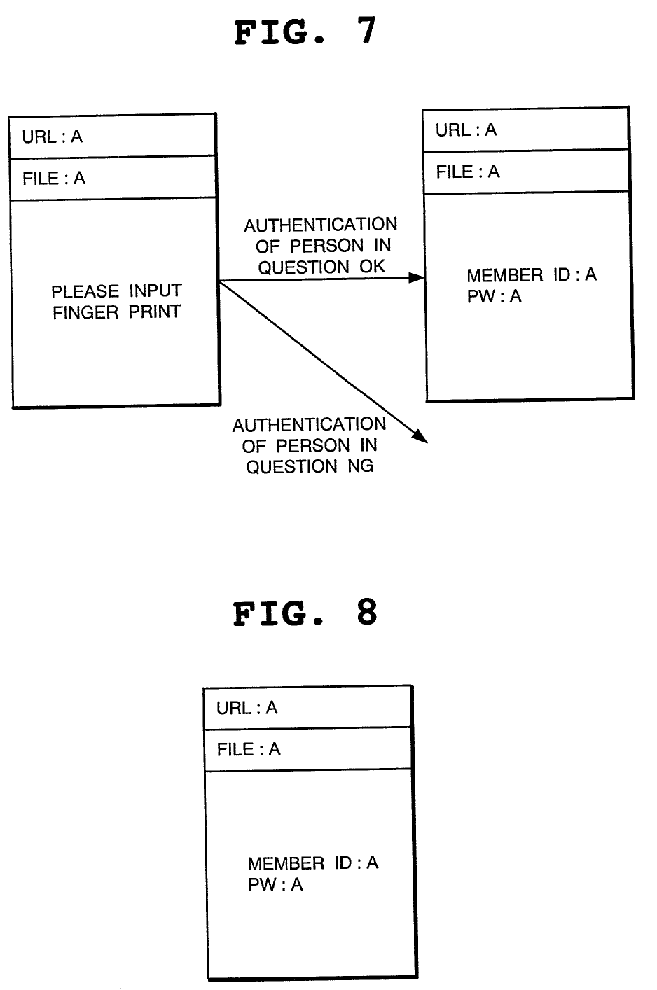

As illustrated in FIG. 7, when an instruction is displayed on the display unit 104 to, for example, input a finger print as one of physical characteristics, the member inputs his or her own finger print through the scanner 102 (Step S502). In response to the input, the processing unit 109 reads the encipherment table 602 registered at the information registration unit 107, decodes physical characteristic information registered by the encipherment and decoding unit 108 and compares the registered physical characteristic information and the input physical characteristic information to conduct authentication thereof (Step S503).

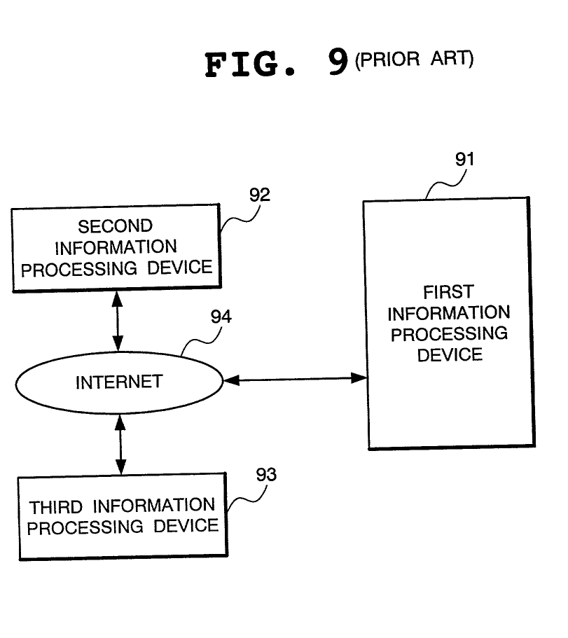

When authentication results coincide with each other, read the encipherment table 602 from the information registration unit 107 and decode the member's personal authentication information using the encipherment and decoding unit 108 to store the information in the temporary file 106 in the form of such personal authentication information table 601 as shown in FIG. 6 (Step S505). Also as shown in FIG. 8, display the member identification information and the password as personal authentication information on the display unit 104. When at the processing at Step S503, if the authentication results fail to coincide with each other, processing is finished (Step S504).

After Step S505, the processing unit 109 transmits the personal authentication information read from the temporary file 106 to the mail-order site side server 112 or 113 through the communication interface unit 110 (Step S506). Then, the mail-order site side server 112 or 113 recognizes the personal authentication information to complete connection (Step S507).

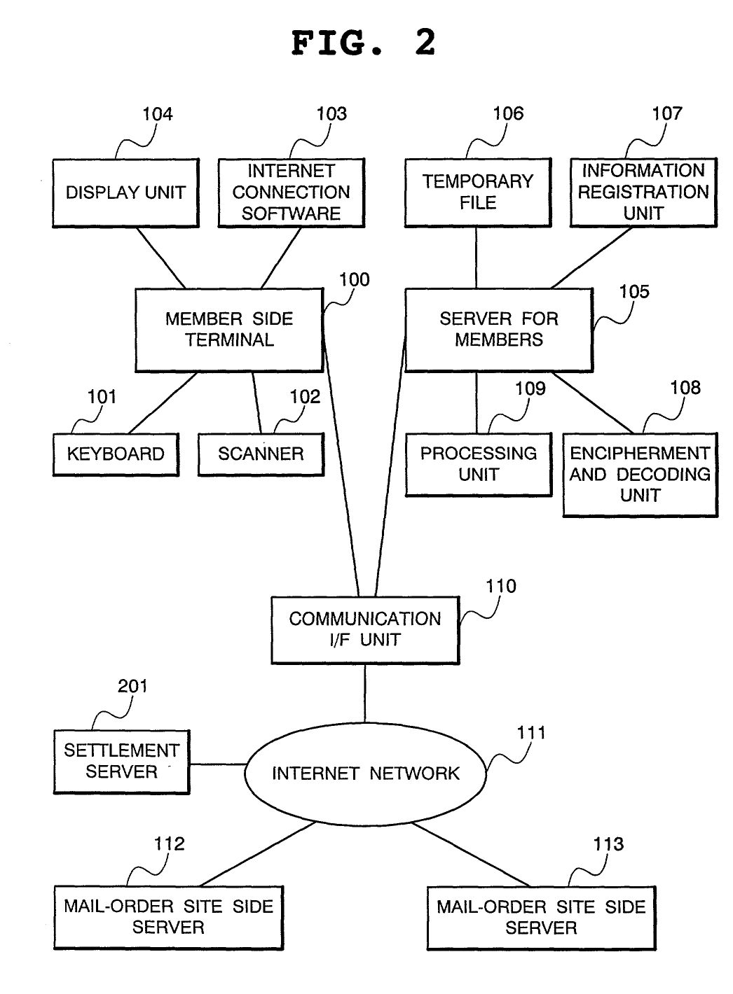

Next, a second embodiment of the present invention will be described with reference to FIG. 2. As the second embodiment of the present invention, illustrated in FIG. 2 is an example of setup of the mail-order system according to the present invention which is applied to a case where a settlement is made for mail-ordering, in which the common components to those of FIG. 1 are given the same reference numerals. In FIG. 2, a user (member) inputs such authentication information for authenticating a card (credit card etc.) by which a settlement for mail-ordering is made as identification information and a password by using the keyboard 101. The input card authentication information is stored in the temporary file 106 for storing card authentication information of a member of the server for members 105 through the communication interface unit 110.

Next, the member inputs his or her own physical characteristics using the scanner 102. The input physical characteristic information is registered at the information registration unit 107 of the server for members 105. Thereafter, the physical characteristic information is enciphered in correlation with the member's card authentication information by the encipherment and decoding unit 108 and stored in the information registration unit 107.

When at the settlement for mail-ordering by the member, he or she inputs his or her own physical characteristics through the scanner 102, the processing unit 109, in response to the input, compares the physical characteristic information with registered information in the information registration unit 107 to conduct authentication thereof and when the authentication results coincide with each other, decodes the member's card authentication information by means of the encipherment and decoding unit 108 to connect to a settlement server 201 of the mail-order site which makes a settlement through the communication interface unit 110.

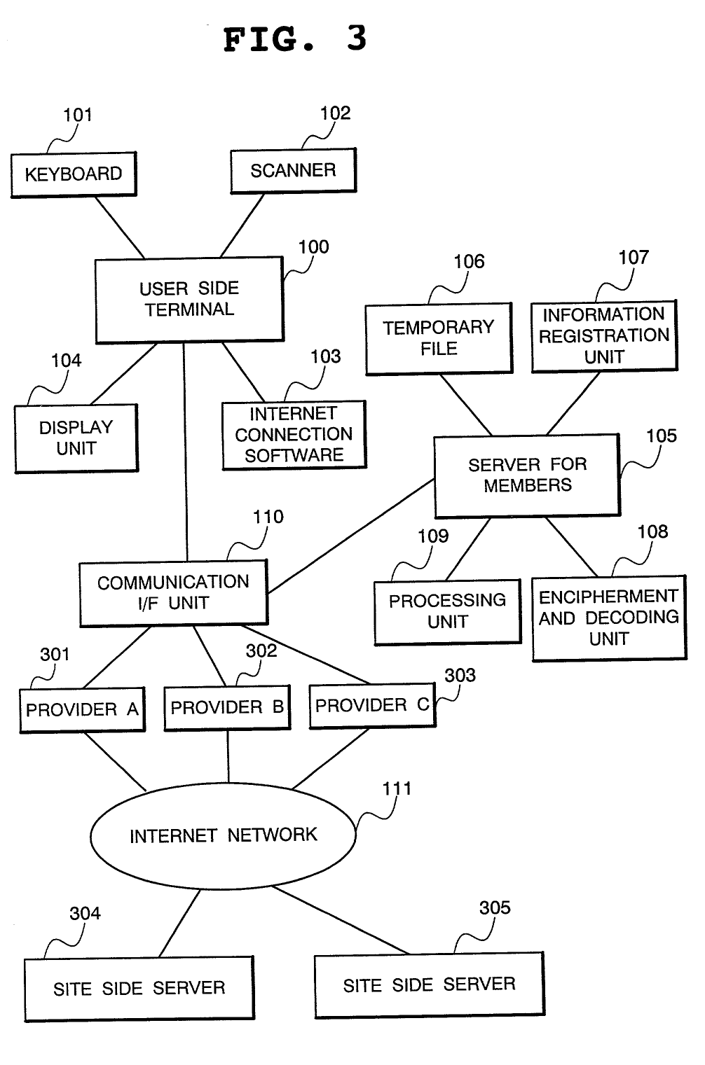

Next, a third embodiment of the present invention will be described with reference to FIG. 3. As the third embodiment of the present invention, illustrated in FIG. 3 is an example of setup of the present invention applied to an Internet connection system, in which the common components to those of FIG. 1 are given the same reference numerals. In FIG. 3, input such authentication information for authenticating a member of a provider as member identification information and a password by using the keyboard 101. The input provider authentication information is stored in the temporary file 106 for storing provider authentication information of a member of the server for members 105 through the communication interface unit 110.

Next, the member inputs his or her own physical characteristics using the scanner 102. The input physical characteristic information is registered at the information registration unit 107 of the server for members 105. Thereafter, the physical characteristic information is enciphered in correlation with the member's provider authentication information by the encipherment and decoding unit 108 and stored in the information registration unit 107.

When connecting to one of a plurality of contracted providers, the member inputs his or her own physical characteristics through the scanner 102, whereby the processing unit 109, in response to the input, compares the physical characteristic information with registered information in the information registration unit 107 to conduct authentication thereof and when the authentication results coincide with each other, decodes the member's provider authentication information by means of the encipherment and decoding unit 108 and selects one of the providers 301 to 303 to connect to the Internet network 111 through the communication interface unit 110.

The system can be also structured such that in a case where the authentication results coincide with each other, at the display of such member's confirmation as shown in FIG. 8, a member may be allowed to select any of a plurality of providers. At this time, the processing unit 109 selects a provider designated by a member and connects the system to the selected provider.

As described in the foregoing, according to the present invention, at the purchase or settlement of a commodity by accessing a server on the side of a site through a network, other than a method using such personal authentication information for authenticating a member or a user as member identification information and a password, registering physical characteristic of each member as physical characteristic information in advance realizes a mail-order system using a network and a method thereof by inputting member's own physical characteristics even when the member forgets his or her personal authentication information or loses his or her own member card, or when the member forgets member identification information and a password for a settlement card or loses a settlement card.

In addition, according to the present invention, at the time of connection to one of a plurality of contracted providers, registering physical characteristics of each member as physical characteristic information in advance, other than a method using such authentication information for authenticating a member of a provider as member identification information and a password, realizes an Internet connection system using a network and a method thereof by inputting member's own physical characteristics even when he or she forgets his or her own personal authentication information.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A mail-order system for members by which a member purchases commodities by accessing a mail-order site side server through a network using such personal authentication information for authenticating a member as member identification information and a password, comprising:
registration unit for registering physical characteristics of each said member in advance; and
processing unit responsive to application of physical characteristics by a purchaser for comparing the applied physical characteristic information and the physical characteristic information registered at said registration unit to conduct authentication and determining whether connection to said mail-order site side server through said network is allowed or not according to authentication results.

2. The mail-order system as set forth in claim 1, further comprising
a server for members for authenticating said member, wherein
said registration unit and said processing unit are provided at said server for members.

3. The mail-order system as set forth in claim 1, further comprising
unit for enciphering said personal authentication information and said physical characteristic information so as to be in correlation with each other and registering the enciphered information at said registration unit, and reading and decoding said information enciphered.

4. The mail-order system as set forth in claim 1, further comprising
unit for enciphering said personal authentication information and said physical characteristic information so as to be in correlation with each other and registering the enciphered information at said registration unit, and reading and decoding said information enciphered, wherein
said decoding unit decodes said personal authentication information when results of authentication of a purchaser's physical characteristics applied at the purchase of a commodity and said registered physical characteristics coincide with each other.

5. The mail-order system as set forth in claim 1, further comprising
unit for enciphering said personal authentication information and said physical characteristic information so as to be in correlation with each other and registering the enciphered information at said registration unit, and reading and decoding said information enciphered, wherein
said decoding unit decodes said personal authentication information when results of authentication of a purchaser's physical characteristics applied at the purchase of a commodity and said registered physical characteristics coincide with each other, and
said processing unit transmits said personal authentication information decoded to said mail-order site side server.

6. A mail-order system for members by which a member makes a settlement for mail-ordering by accessing a mail-order settlement server through a network using such authentication information for authenticating a card of a member who makes a settlement for mail-ordering as identification information and a password, comprising:
registration unit for registering physical characteristics of each said member in advance; and
processing unit responsive to application of physical characteristics of one who makes a settlement and to application of physical characteristics by a purchaser for comparing the applied physical characteristic information and the physical characteristic information registered at said registration unit to conduct authentication and determining whether connection to said mail-order settlement server through said network is allowed or not according to authentication results.

7. The mail-order system as set forth in claim 6, further comprising
a server for members for authenticating said member, wherein
said registration unit and said processing unit are provided at said server for members.

8. The mail-order system as set forth in claim 6, further comprising
unit for enciphering said personal authentication information and said physical characteristic information so as to be in correlation with each other and registering the enciphered information at said registration unit, and reading and decoding said information enciphered.

9. The mail-order system as set forth in claim 6, further comprising
unit for enciphering said personal authentication information and said physical characteristic information so as to be in correlation with each other and registering the enciphered information at said registration unit, and reading and decoding said information enciphered, wherein
said decoding unit decodes said personal authentication information when results of authentication of physical characteristics of one who makes a settlement applied at the settlement of mail-ordering and said registered physical characteristics coincide with each other.

10. The mail-order system as set forth in claim 6, further comprising
unit for enciphering said personal authentication information and said physical characteristic information so as to be in correlation with each other and registering the enciphered information at said registration unit, and reading and decoding said information enciphered, wherein
said decoding unit decodes said personal authentication information when results of authentication of physical characteristics of one who makes a settlement applied at the settlement of mail-ordering and said registered physical characteristics coincide with each other, and
said processing unit transmits said personal authentication information decoded to said mail-order settlement server.

11. An Internet connection system enabling connection to at least one of contracted providers by member's access to the Internet through a network using such personal authentication information for authenticating a member as member identification information and a password, comprising:
registration unit for registering physical characteristics of each said member in advance, and
processing unit responsive to application of physical characteristics by one who makes a connection for comparing the applied physical characteristic information and the physical characteristic information registered at said registration unit to conduct authentication and determining whether connection to said provider through said network is allowed or not according to authentication results.

12. The Internet connection system as set forth in claim 11, further comprising
a server for members for authenticating said member, wherein
said registration unit and said processing unit are provided at said server for members.

13. The Internet connection system as set forth in claim 11, further comprising
unit for enciphering said personal authentication information and said physical characteristic information so as to be in correlation with each other and registering the enciphered information at said registration unit, and reading and decoding said information enciphered.

14. The Internet connection system as set forth in claim 11, further comprising
unit for enciphering said personal authentication information and said physical characteristic information so as to be in correlation with each other and registering the enciphered information at said registration unit, and reading and decoding said information enciphered, wherein
said decoding unit decodes said personal authentication information when results of authentication of physical characteristics of one who makes a connection applied at the connection and said registered physical characteristics coincide with each other.

15. The Internet connection system as set forth in claim 11, further comprising
unit for enciphering said personal authentication information and said physical characteristic information so as to be in correlation with each other and registering the enciphered information at said registration unit, and reading and decoding said information enciphered, wherein
said decoding unit decodes said personal authentication information when results of authentication of physical characteristics of one who makes a connection applied at the connection and said registered physical characteristics coincide with each other, and
said processing unit transmits said personal authentication information decoded to said provider.

16. A mail-ordering method for members by which a member purchases commodities by accessing a mail-order site side server through a network using such personal authentication information for authenticating a member as member identification information and a password, comprising the steps of:
registering physical characteristics of each said member in advance; and
in response to application of physical characteristics by a purchaser, comparing the applied physical characteristic information and the physical characteristic information registered at said registration unit to conduct authentication and determining whether connection to said mail-order site side server through said network is allowed or not according to authentication results.

17. The mail-ordering method as set forth in claim 16, further comprising the step of
enciphering said personal authentication information and said physical characteristic information so as to be in correlation with each other and registering the enciphered information at said registration unit, and reading and decoding said information enciphered.

18. The mail-ordering method as set forth in claim 16, further comprising the step of
enciphering said personal authentication information and said physical characteristic information so as to be in correlation with each other and registering the enciphered information at said registration unit, and reading and decoding said information enciphered, wherein
said personal authentication information is decoded when results of authentication of a purchaser's physical characteristics applied at the purchase of a commodity and said registered physical characteristics coincide with each other.

19. The mail-ordering method as set forth in claim 16, further comprising the step of
enciphering said personal authentication information and said physical characteristic information so as to be in correlation with each other and registering the enciphered information at said registration unit, and reading and decoding said information enciphered, wherein
said personal authentication information is decoded when results of authentication of a purchaser's physical characteristics applied at the purchase of a commodity and said registered physical characteristics coincide with each other, and
said personal authentication information decoded is transmitted to said mail-order site side server.

20. A mail-ordering method for members by which a member makes a settlement for mail-ordering by accessing a mail-order settlement server through a network using such authentication information for authenticating a card of a member who makes a settlement for mail-ordering as identification information and a password, comprising the steps of:
registering physical characteristics of each said member in advance; and
in response to application of physical characteristics of one who makes a settlement and to application of physical characteristics by a purchaser for comparing the applied physical characteristic information and the physical characteristic information registered at said registration unit to conduct authentication and determining whether connection to said mail-order settlement server through said network is allowed or not according to authentication results.

21. The mail-ordering method as set forth in claim 20, further comprising the step of
enciphering said personal authentication information and said physical characteristic information so as to be in correlation with each other and registering the enciphered information at said registration unit, and reading and decoding said information enciphered.

22. The mail-ordering method as set forth in claim 20, further comprising the step of
enciphering said personal authentication information and said physical characteristic information so as to be in correlation with each other and registering the enciphered information at said registration unit, and reading and decoding said information enciphered, wherein
said personal authentication information is decoded when results of authentication of physical characteristics of one who makes a settlement applied at the settlement of mail-ordering and said registered physical characteristics coincide with each other.

23. The mail-ordering method as set forth in claim 20, further comprising the step of
enciphering said personal authentication information and said physical characteristic information so as to be in correlation with each other and registering the enciphered information at said registration unit, and reading and decoding said information enciphered, wherein
said personal authentication information is decoded when results of authentication of physical characteristics of one who makes a settlement applied at the settlement of mail-ordering and said registered physical characteristics coincide with each other, and
said personal authentication information decoded is transmitted to said mail-order settlement server.

24. An Internet connection method enabling connection to at least one of contracted providers by member's access to the Internet through a network using such personal authentication information for authenticating a member as member identification information and a password, comprising the steps of:
registering physical characteristics of each said member in advance; and
in response to application of physical characteristics by one who makes a connection, comparing the applied physical characteristic information and the physical characteristic information registered at said registration unit to conduct authentication and determining whether connection to said provider through said network is allowed or not according to authentication results.

25. The Internet connection method as set forth in claim 24, further comprising the step of
enciphering said personal authentication information and said physical characteristic information so as to be in correlation with each other and registering the enciphered information at said registration unit, and reading and decoding said information enciphered.

26. The Internet connection method as set forth in claim 24, further comprising the step of
enciphering said personal authentication information and said physical characteristic information so as to be in correlation with each other and registering the enciphered information at said registration unit, and reading and decoding said information enciphered, wherein
said personal authentication information is decoded when results of authentication of physical characteristics of one who makes a connection applied at the connection and said registered physical characteristics coincide with each other.

27. The Internet connection method as set forth in claim 24, further comprising the step of
enciphering said personal authentication information and said physical characteristic information so as to be in correlation with each other and registering the enciphered information at said registration unit, and reading and decoding said information enciphered, wherein
said personal authentication information is decoded when results of authentication of physical characteristics of one who makes a connection applied at the connection and said registered physical characteristics coincide with each other, and
said personal authentication information decoded is transmitted to said provider.
